(19) United States
(12) Patent Application Publication
(10) Pub. No.: US 2021/0035702 A1
(43) Pub. Date: Feb. 4, 2021

(54) SILVER NANOWIRE INK AND TRANSPARENT ELECTROCONDUCTIVE FILM

(71) Applicant: SHOWA DENKO K. K., Tokyo (JP)

(72) Inventors: Shuhei YONEDA, Tokyo (JP); Suguru SAKAGUCHI, Tokyo (JP); Takashi SATO, Tokyo (JP); Yoshishige OKUNO, Tokyo (JP)

(73) Assignee: SHOWA DENKO K. K., Tokyo (JP)

(21) Appl. No.: 17/046,526

(22) PCT Filed: Mar. 26, 2019
(86) PCT No.: PCT/JP2019/012787

§ 371 Date: Oct. 9, 2020

(30) Foreign Application Priority Data
Apr. 12, 2018 (JP) 2018-076725

(51) Int. Cl. H01B 1/22; H01B 5/14; C09D 11/52; B32B 27/18; C09D 11/03

(52) U.S. Cl. CPC H01B 1/22; H01B 5/14; C09D 11/03; B32B 27/18; C09D 11/52

(57) ABSTRACT

A silver nanowire ink capable of obtaining a transparent electroconductive pattern having a preferable conductivity and a superior migration resistance, and capable of being produced by smaller steps, as well as a transparent electroconductive film using the silver nanowire ink. A silver nanowire ink including a low molecular weight urea compound having a urea bond in a molecule and having a molecular weight of 60 to 250, a silver nanowire, a binder resin, and a dispersion medium, and a transparent electroconductive film obtained by coating the silver nanowire ink on a transparent substrate and drying the same.

### TECHNICAL FIELD

The present disclosure relates to a silver nanowire ink for forming a transparent electroconductive pattern and a transparent electroconductive film having a substrate on which the silver nanowire ink is coated.

### BACKGROUND ART

When a transparent electroconductive pattern containing silver nanowires as an electroconductive member is applied with voltage under high humidity and high temperature environment, a phenomenon that silver ions dissolved from the silver nanowires are diffused between the transparent electroconductive patterns (migration) may be observed. This phenomenon can cause short-circuit between the patterns or deterioration of the patterns, and thus, there has been a desire for suppressing the diffusion of the silver ions and increasing tolerance against migration between the transparent electroconductive patterns.

The below-mentioned Patent Document 1 to Patent Document 3 disclose a silver nanowire containing electroconductive pattern member and an electroconductive paste capable of suppressing the diffusion of silver ions by adding an ion scavenger, a corrosion inhibitor, and a chelating reagent.

However, according to the method described in Patent Document 1 after silver nanowires are coated on a substrate, another step for adding a silver ion scavenger is required, resulting in complicating the process.

Further, the corrosion inhibitor used in Patent Document 2 and the chelator used in Patent Document 3 bring out the effects when stuck to the surface of metal nanowires, and thus, they may prevent the contact between nanowires to worsen the conductivity.

### PRIOR ARTS

### Patent Document

Patent Document 1: Japanese Unexamined Patent Publication (Kokai) No. 2013-201003
Patent Document 2: Japanese Unexamined Patent Publication (Kokai) No. 2009-505358
Patent Document 3] Japanese Unexamined Patent Publication (Kokai) No. 2006-260885

### SUMMARY

One of the objectives of the present disclosure is to provide a silver nanowire ink capable of obtaining a transparent electroconductive pattern having a preferable conductivity and a superior migration resistance, and capable of being produced by fewer steps, as well as a transparent electroconductive film using the silver nanowire ink.

### Solving Means

In order to achieve the above objective, one aspect of the present disclosure is as follows.

[1] A silver nanowire ink comprising a low molecular weight urea compound having a urea bond in a molecule and having a molecular weight of 60 to 250, a silver nanowire, a binder resin, and a dispersion medium.

[2] A silver nanowire ink according to [1], wherein a content of the low molecular weight urea compound in the silver nanowire ink is 0.02 to 0.20% by mass, a content of the silver nanowire is 0.01 to 1.50% by mass, and a content of the binder resin is 0.01 to 2.00% by mass.

[3] A silver nanowire ink according to [1] or [2], wherein the low molecular weight urea compound is at least one selected from a group consisting of urea and a substituted urea compound in which one or two hydrogen atoms in the urea is substituted by an alkyl group with 1 to 3 carbon atoms or a phenyl group.

[4] A silver nanowire ink according to any one of [1] to [3], wherein the binder resin is ethyl cellulose or poly-N-vinylpyrrolidone.

[5] A silver nanowire ink according to any one of [1] to [4], wherein the dispersion medium contains water and at least one saturated monohydric alcohol having 1 to 3 carbon atoms and represented by CₙH₂ₙ₊₁OH (n being an integer of 1 to 3).

[6] A silver nanowire ink according to [5], wherein the dispersion medium further contains at least one selected from a group consisting of ethylene glycol, propylene glycol, ethylene glycol monomethylether, ethylene glycol monoethylether, propylene glycol monomethylether, and propylene glycol monoethylether.

[7] A transparent electroconductive film having a transparent substrate on which a transparent electroconductive layer made of a silver nanowire ink according to any one of the above [1] to [6] is formed.

[8] A transparent electroconductive film according to [7], wherein the transparent substrate is a film of cyclo olefin polymer, polycarbonate, or polyethylene terephthalate.

### Effect of the Invention

Using a silver nanowire ink and a transparent electroconductive film according to the present disclosure, a transparent electroconductive pattern having a preferable conductivity and a superior migration resistance can be provided.

### Aspects of Disclosure

Hereinbelow, an aspect of the present disclosure (hereinbelow, referred to as an aspect) will be explained, but the present disclosure is not limited to those aspects as far as not departing from the scope of the present disclosure.

The first aspect of the present disclosure is a silver nanowire ink having a feature that the silver nanowire ink contains a low molecular weight urea compound having a urea bond in a molecule and having a molecular weight of 60 to 250, a silver nanowire, a binder resin, and a dispersion medium

### <Low Molecular Weight Urea Compound Having Urea Bond in Molecule and Having 60-250 Molecular Weight>

A silver nanowire ink according to the present aspect contains a low molecular weight urea compound having a urea bond in a molecule and having a molecular weight of 60 to 250 (hereinbelow, may be referred to as “low molecular weight urea compound”). When the silver nanowire ink contains a compound having a urea bond in a molecule, there are effects that a transparent electroconductive film formed by the silver nanowire ink can maintain a preferable conductivity and can improve a migration resistance, although the mechanism how the effects are brought out is unclear. If the molecular weight is 250 or less, solubility to the ink solvent (dispersion medium) is preferable. The urea bond can be represented by (—NH—C(═O)—NH—), and a representative example of a compound having a urea bond is urea (molecular weight: 60.1). Further, the compound may be a N-substituted urea compound in which at least one hydrogen atom bonded to a nitrogen atom of urea is substituted by other substituent such as an alkyl group having 1 to 13 carbon atoms or a cycloalkyl group having 1 to 13 carbon atoms, or an aryl group having 6 to 14 carbon atoms. Examples of N-substituted urea include: 1-methylurea, 1-ethylurea, 1-propylurea, 1-butylurea, 1-pentylurea, 1-hexylurea, 1-octylurea, 1-decylurea, 1-cyclopentylurea, 1-cyclohexylurea, 1-cyclooctylurea, 1-(phenylethyl)urea, 1-(phenylbutyl)urea, 1-(phenyloctyl)urea, 1-phenylurea, 1-(methylphenyl)urea, 1-(ethylphenyl)urea, 1-(propylphenyl)urea, 1-(butylphenyl)urea, 1-(pentylphenyl)urea, 1-(hexylphenyl)urea, 1-(heptylphenyl)urea, 1-(octylphenyl)urea, 1-(biphenyl)urea, 1-(dimethylphenyl)urea, 1-(diethylphenyl)urea, 1-(dipropylphenyl)urea, 1-(dibutylphenyl)urea, 1-(trimethylphenyl)urea, 1-(triethylphenyl)urea, 1-(phenylmethyl)urea, 1-(phenylethyl)urea, 1-(phenylpropyl)urea, 1-(phenylbutyl)urea, 1-(phenylpentyl)urea, 1-(phenylhexyl)urea, 1-(phenylheptyl)urea, 1-(phenyloctyl)urea, 1,3-dimethylurea, 1,3-diethylurea, 1,3-dipropylurea, 1,3-dibutylurea, 1,3-dipentylurea, 1,3-dihexylurea, 1,3-dicyclopentylurea, 1,3-dicyclohexylurea, 1,3-diphenylurea, 1,3-di(methylphenyl)urea, 1,3-di(dimethylphenyl)urea, 1,3-di(phenylmethyl)urea, and the like. Among these urea compounds, in view of the mixing amounts taking the solubility to the below-mentioned dispersion medium and the molecular weight into account, at least one selected from a group consisting of urea and a substituted urea compound in which one or two hydrogen atoms in the urea is substituted by an alkyl group with 1 to 3 carbon atoms or a phenyl group is preferable, and urea is more preferable.

A content of the low molecular weight urea compound in the silver nanowire ink is preferably 0.02 to 0.20% by mass, more preferably 0.03 to 0.15% by mass, still more preferably 0.03 to 0.10% by mass, and particularly preferably 0.03 to 0.07% by mass. If the content is 0.02% by mass or more, the film obtained by coating the silver nanowire ink shows a preferable migration resistance. If the content is 0.20% by mass or less, after the silver nanowire ink is coated and dried, precipitation of crystals of the compound having a urea bond in a molecule can be prevented.

### <Silver Nanowire>

The silver nanowire ink according to the present aspect includes a silver nanowire as an electroconductive material. The silver nanowire is silver having a diameter in the order of nanometer with a high aspect ratio in one-dimensional direction, and is an electroconductive material having a wire shape or a tubular shape. In the present specification, both the “wire” shape and the “tubular” shape refer to a linear shape, and the former is not hollow, whereas the latter is hollow. They may be soft or rigid. The former is referred to as “silver nanowire in a narrow sense”, and the latter is referred to as “silver nanotube in a narrow sense”. Hereinbelow, in the present specification, “silver nanowire” is used to include both the silver nanowire in a narrow sense and the silver nanotube in the narrow sense. Either the silver nanowire in a narrow sense or the silver nanotube in a narrow sense may be used solely, but they may be mixed.

Regarding the diameter of the silver nanowire, the narrower is preferable in view of the transparency (total light transmittance).

Therefore, an average value of the wire diameter is preferably 100 nm or less, more preferably 50 nm or less, and still more preferably 40 nm or less. On the other hand, in view of the strength and easy handling, 2 nm or more is preferable, 5 nm or more is more preferable, and 10 nm or more is still more preferable.

Further, regarding the average length of the major axis of the silver nanowire, the longer is preferable in view of the conductivity. However, in order to apply to a fine pattern, the length should be restricted to some extent. Accordingly, the average value of the wire length, from the viewpoint of conductivity, is preferably 2 μm or more, more preferably 5 μm or more, and still more preferably 10 μm or more. On the other hand, from the viewpoint of applicability to a fine pattern, 100 μm or less is preferable, 50 μm or less is more preferable, and 40 μm or less is still more preferable.

While the average size of the diameter and the average length of the major axis satisfy the above-mentioned ranges, an average of the aspect ratio of the silver nanowire is preferably 100 or more, more preferably 200 or more, and still more preferably 300 or more. Here, the aspect ratio refers to a value obtained by a/b, wherein “b” represents an average diameter size of the silver nanowire and “a” represents an average major axis length thereof. The values “a” and “b” are obtained by measuring the diameters and lengths of any selected 100 nanowires by using a scanning electron microscope, and calculating arithmetic averages of these.

The silver nanowire content in the ink is preferably 0.01 to 1.50% by mass, more preferably 0.05 to 1.00% by mass, still more preferably 0.10 to 0.50% by mass, and particularly preferably 0.15 to 0.30% by mass. If the content is 0.01% by mass or more, the film obtained by coating shows a preferable conductivity. If the content is 1.50% by mass or less, the film obtained by coating shows a preferable optical property (high total light transmittance).

### <Binder Resin>

A binder resin which can be used for the silver nanowire ink is not limited, as far as the silver nanowires can be uniformly dispersed in the ink, and can be preferably adhered to the transparent substrate when formed into a film. In order to obtain both the dispersibility of the silver nanowires and the adhesiveness to the substrate, a hydrophilic resin is preferable. Examples of the resin includes: a poly-N-vinyl compound such as poly-N-vinylpyrrolidone, poly-N-vinylcaprolactam, and poly-N-vinylacetamide; a cellulose compound such as ethyl cellulose, hydroxyethyl cellulose, hydroxypropylcellulose, and acetylcellulose; a polyalkylene glycol compound such as polyethylene glycol, polypropylene glycol, polytetramethylene ether glycol; and the like. In particular, ethyl cellulose and poly-N-vinylpyrrolidone are preferable.

The binder resin content in the ink is preferably 0.01 to 2.00% by mass, more preferably 0.03 to 1.60% by mass, still more preferably 0.15 to 1.20% by mass, and particularly preferably 0.03 to 0.80% by mass. If the content is 0.01% by mass or more, the coated film can uniformly formed, and also, adhesiveness between the silver nanowires and the transparent substrate can be ensured. If the content is 2.00% by mass or less, the film obtained by coating shows a preferable conductivity.

### <Dispersion Medium>

A dispersion medium which can be used for the silver nanowire ink according to the present aspect is not limited, as far as the above-mentioned low molecular weight urea compound and binder resin can be dissolved therein, and the silver nanowires can be dispersed therein. In the point that the silver nanowires can be dispersed well, a polar solvent is preferable. The polar solvent may be water or alcohol in view of the characteristics of easily controlling the drying speed, and the mixed solvent of these is preferable. The alcohol content in the mixed solvent is preferably 85% by mass or more and 95% by mass or less. Preferable alcohols are saturated monohydric alcohols having 1 to 3 carbon atoms (methanol, ethanol, n-propanol, isopropanol), which are represented by CₙH₂ₙ₊₁OH (n being an integer of 1 to 3). The above-mentioned saturated monohydric alcohol having 1 to 3 carbon atoms is contained preferably 20% by mass or more and 95% by mass or less in the alcohol, more preferably 25% by mass or more and 85% by mass or less in the alcohol, and still more preferably 30% by mass or more and 70% by mass or less in the alcohol. Using the saturated monohydric alcohol having 1 to 3 carbon atoms is advantageous because drying process becomes easy.

Alcohols other than the saturated monohydric alcohol having 1 to 3 carbon atoms can be used together. Examples of other alcohols which can be used together with the saturated monohydric alcohol having 1 to 3 carbon atoms include ethylene glycol, propylene glycol, ethylene glycol monomethylether, ethylene glycol monoethylether, propylene glycol monomethylether, propylene glycol monoethylether, and the like. The alcohol other than the saturated monohydric alcohol having 1 to 3 carbon atoms is contained preferably 5% by mass or more and 80% by mass or less in the alcohol, more preferably 15% by mass or more and 75% by mass or less in the alcohol, and still more preferably 30% by mass or more and 70% by mass or less in the alcohol. Using such alcohol together with the saturated monohydric alcohol having 1 to 3 carbon atoms is advantageous because the drying speed can be adjusted.

The content of water in the mixed solvent is preferably 5% by mass or more and 15% by mass or less, and more preferably 5% by mass or more and 10% by mass or less. If the water content in the mixed solvent is less than 5% by mass, when the ink is coated on the substrate, cissing may be observed, and coating may not be possible. Accordingly, a preferably content ratio (mass ratio) of (S1) water, (S2) the saturated monohydric alcohol having 1 to 3 carbon atoms, and (S3) alcohol other than the saturated monohydric alcohol having 1 to 3 carbon atoms, in the mixed solvent of alcohol and water is that (S1):(S2):(S3) satisfies 5 to 15:80 to 25:15 to 70, and a more preferable content ratio (mass ratio) is that (S1):(S2):(S3) satisfies 5 to 15:65 to 30:30 to 65 (with the proviso that, (S1)+(S2)+(S3)=100))

The silver nanowire ink according to the present aspect may contain an additive such as a surfactant, an antioxidant, a filler, etc., as far as there are no bad influences on properties such as a printing property, a conductivity, an optical property, etc. In order to adjust the viscosity of a composition, a filler such as fumed silica may be used. The mixing amount of such additives in total in the metal nanowire ink is preferably 5% by mass or less.

The second aspect of the present disclosure is a transparent electroconductive film having a transparent substrate on which a transparent electroconductive layer made of the above-mentioned silver nanowire ink is formed.

### <Transparent Substrate>

A transparent substrate that can be used in the present aspect is not limited as far as it is transparent, and may be colored. Higher total light transmittance (transparency to visible light) is preferable, and a preferable total light transmittance is 80% or more. A material of the transparent substrate is not particularly limited, but in view of the flexibility and bending resistance, a resin film is preferable. For the resin film, for example, polyester (polyethylene terephthalate [PET], polyethylene naphthalate [PEN], etc.), polycarbonate, acrylic resin (poly methyl methacrylate [PMMA], etc.), cyclo olefin polymer, and the like may be preferably used. Among these resin films, in view of a superior light transmittance(transparency), flexibility, and a mechanical property, using a cyclo olefin polymer, polycarbonate, polyethylene terephthalate is more preferable. For the cyclo olefin polymer, a hydrogenated ring-opening metathesis polymerization type cyclo olefin polymer of norbornene (ZEONOR (registered trademark, manufactured by Zeon Corporation), ZEONEX (registered trademark, manufactured by Zeon Corporation), ARTON (registered trademark, manufactured by JSR Corporation), etc.) and a norbornene/ethylene addition copolymerization type cyclo olefin polymer (APEL (registered trademark, manufactured by Mitsui Chemicals, Inc.), TOPAS (registered trademark, manufactured by Polyplastics Co., Ltd.)) can be used.

In order to be break proof when the resin film is bent, the thickness of the resin film is preferably 350 μm or less, more preferably 200 μm or less, and still more preferably 125 μm or less. Further, in order to handle the resin film easily, the thickness is preferably 10 μm or more, more preferably 20 μm or more, and still more preferably 35 μm or more.

### <Forming Transparent Electroconductive Layer>

A transparent electroconductive layer is formed on the above-mentioned transparent substrate by coating the above-mentioned silver nanowire ink on the transparent substrate and dried. Thereby, a transparent electroconductive film according to the present aspect can be formed.

A coating method of the silver nanowire ink may any known method without limitation, and spray coating, bar coating, roll coating, die coating, inkjet coating, screen coating, dip coating, relief printing, intaglio printing, gravure printing, and the like can be used. In particular, from the viewpoint that large area coating is easy, bar coating and die coating are preferable. The shape of the transparent electroconductive layer thus formed is not limited, but may be a shape of wire or electrode pattern formed on the transparent substrate, or a shape of film (solid pattern) covering a part or the entirety of the transparent substrate, and the like. The formed transparent electroconductive layer is heated to dry the solvent (dispersion medium), and to thereby become electroconductive. In accordance with needs, the conducive pattern may be subjected to appropriate photoirradiation.

### EXAMPLES

Hereinafter, specific examples of the present disclosure will be explained. The examples are described below for the purpose of easy understanding of the present disclosure, and the present disclosure is not limited to these examples.

### <Outline of Transparent Electroconductive Film Evaluation Method>

After a silver nanowire ink was produced, the ink is coated on a film (transparent substrate) and dried, and thereby, a transparent electroconductive film was produced. The transparent electroconductive film was subjected to laser etching to form a slit part. A voltage is applied under a high humidity high temperature environment, and whether or not the slit part is short-circuited was examined. The film that was not short-circuited was determined as having a migration resistance, and the film that was short-circuited was determined as having no migration resistance.

Further, surface resistance values and total light transmittance of the transparent electroconductive films were also measured.

### <Producing Silver Nanowire Ink>

Raw materials were mixed in the mixing ration shown in Table 1, and stirred by a Mix Rotor VMR-5R (manufactured by AS ONE Corporation) for 3 hours, at a room temperature and under an air atmosphere (rotation speed: 100 rpm), to thereby produce 10 g of silver nanowire ink. In Table 1, as a nitrogen-containing compound, low molecular weight urea compounds which were urea (molecular weight: 60.1), 1,3-dimethylurea (molecular weight: 88.1), 1,3-diethylurea (molecular weight: 116.2), 1-phenylurea (molecular weight: 136.2), and 1,3-diphenylurea (molecular weight: 212.3) were used, and in the below-mentioned comparative examples, benzotriazole was used. The urea, 1,3-dimethylurea, 1,3-diethylurea, 1-phenylurea, and 1,3-diphenylurea are reagents manufactured by Tokyo Chemical Industry Co., Ltd., and benzotriazole is a reagent manufactured by FUJIFILM Wako Pure Chemical Corporation. Silver nanowires synthesized by the polyol method, and having an average diameter of 26 nm and an average length of 18 μm were used. The average diameter and the average length were calculated by using Field Emission Scanning Electron Microscope JSM-7000F (manufactured by JEOL Ltd.). Sizes of arbitrarily selected 100 silver nanowires were measured, and arithmetic average values thereof were calculated. Regarding the binder resin, Sokalan (registered trademark) K-90 (weight-average molecular weight of 350,000) manufactured by BASF was used as poly-N-vinylpyrrolidone (PVP), and ETHOCEL (registered trademark) STD100CPS (weight-average molecular weight of 180,000) manufactured by Nisshin Kasei Co., Ltd., was used as ethyl cellulose, Regarding the dispersion medium, reagents manufactured by FUJIFILM Wako Pure Chemical Corporation were used for methanol, ethanol, propylene glycol monomethyl ether (PGME), and a reagent manufactured by AGC Inc., was used for propylene glycol (PG).

### <Producing Transparent Electroconductive Film>

A cyclo olefin polymer film ZF14-100 (manufactured by Zeon Corporation) of A4 size was subjected to plasma treatment (used gas: nitrogen, feed speed: 50 mm/sec, treatment time: 6 sec, set voltage: 400V) using a plasma processing equipment (AP-T03 manufactured by Sekisui Chemical Co., Ltd.). A silver nanowire ink was coated on the entire surface of the substrate (ZF14-100) to have a wet film thickness of 15 μm, by using IMC-70F0-C type coater (manufactured by Imoto Machinery Co., Ltd.) and a spiral coater (manufactured by TQC Corporation). Thereafter, the coated film was subjected to hot-air drying at 100° C., for 10 minutes, and under an air atmosphere, by using a constant temperature oven HISPEC HS350 (manufactured by Kusumoto Chemicals Ltd.), and thereby a transparent electroconductive film was obtained.

### [Migration Resistance Evaluation]

### <Laser Etching>

Etching was performed to form one slit of 30 μm width on the transparent electroconductive film, by using a green laser marker LP-G(manufactured by SUNX Co., Ltd.).

### <Voltage Applying Test>

The above-mentioned sample subjected to etching was cut into a 10 cm*2 cm rectangle piece with the slit at the center of the long side. The transparent electroconductive film was soldered to the migration tester MIG-8600B (manufactured by IMV corporation) at its opposite ends of the rectangle piece, and the rectangle piece was placed in a constant temperature constant humidity chamber for migration testers, THC-120 (manufactured by IMV corporation), to which voltage of 5 V was applied under an environment of temperature 85° C. and relative humidity 85%, for 130 hours. Thereafter, presence/absence of conduction (short-circuit) was determined.

### [Surface Resistance Measurement]

A test piece of 3 cm*3 cm was cut from the above-mentioned A4-size transparent electroconductive film formed by coating the silver nanowire ink on the entire surface of the film. Measurement was performed by contacting substrate of the hand held probe type eddy current sheet resistance/resistivity measurement instrument EC-80P (manufactured by Napson Corporation) onto the center of the piece.

### [Total Light Transmittance Measurement]

Using the above-mentioned test piece of 3 cm*3 cm, measurement was performed by a haze meter NDH2000 (manufactured by Nippon Denshoku Industries Co., Ltd.).

Table 1 shows silver nanowire ink compositions used for evaluation and evaluation results of obtained transparent electroconductive films. In the table, the measurement values of the surface resistance and the total light transmittance are measurement values before the migration resistance evaluation.

TABLE 1

| | Silver Nanowire Ink | | | | | | Evaluation Result | | |
|---|---|---|---|---|---|---|---|---|---|
| | Nitrogen-Containing | | Silver | | | Dispersion | Surface | | Short- |
| | Compound | | Nanowire | Binder Resin | | Medium | Resistance | Total Light | Circuit/Migration |
| | Kind | mass % | mass % | Kind | mass % | mass % | Ω/sq | Transmttance % | Resistance |
| Example 1 | urea | 0.04 | 0.25 | PVP | 0.18 | 99.53 | 46 | 90 | Absent/Good |
| Example 2 | urea | 0.04 | 0.25 | ETHOCEL | 0.18 | 99.53 | 42 | 90 | Absent/Good |
| Example 3 | 1,3-dimethylurea | 0.04 | 0.25 | PVP | 0.18 | 99.53 | 42 | 90 | Absent/Good |
| Example 4 | 1,3-dimethylurea | 0.04 | 0.25 | ETHOCEL | 0.18 | 99.53 | 42 | 90 | Absent/Good |
| Example 5 | 1,3-diethylurea | 0.04 | 0.25 | PVP | 0.18 | 99.53 | 41 | 90 | Absent/Good |
| Example 6 | 1,3-diethylurea | 0.04 | 0.25 | ETHOCEL | 0.18 | 99.53 | 42 | 90 | Absent/Good |
| Example 7 | 1-phenylurea | 0.04 | 0.25 | PVP | 0.18 | 99.53 | 47 | 90 | Absent/Good |
| Example 8 | 1-phenylurea | 0.04 | 0.25 | ETHOCEL | 0.18 | 99.53 | 41 | 90 | Absent/Good |
| Example 9 | 1,3-diphenylurea | 0.04 | 0.25 | PVP | 0.18 | 99.53 | 43 | 90 | Absent/Good |
| Example 10 | 1,3-diphenylurea | 0.04 | 0.25 | ETHOCEL | 0.18 | 99.53 | 44 | 90 | Absent/Good |
| Comparative | — | — | 0.25 | PVP | 0.18 | 99.57 | 43 | 90 | Present/Poor |
| Example 1 | | | | | | | | | |
| Comparative | — | — | 0.25 | ETHOCEL | 0.18 | 99.57 | 41 | 90 | Present/Poor |
| Example 2 | | | | | | | | | |
| Comparative | benzotriazole | 0.04 | 0.25 | PVP | 0.18 | 99.53 | 1000< | 90 | No evalution due to |
| Example 3 | | | | | | | | | high resistance |
| Comparative | benzotriazole | 0.04 | 0.25 | ETHOCEL | 0.18 | 99.53 | 56 | 90 | No evalution due to |
| Example 4 | | | | | | | | | high resistance |

All dispersion medium in the table has a composition of water/methanol/ethanol/PGME/PG = 10:10:40:34:6 (mass ration)

In each of Examples 1 to 10 using a silver nanowire ink to which a low molecular weight urea compound was mixed, no short-circuit occurred even after a voltage was applied, and the migration resistance was good. On the other hand, in each of Comparative Examples 1 and 2 using a silver nanowire ink to which no low molecular weight urea compound was mixed, short-circuit occurred when a voltage was applied, and the migration resistance was poor. Regarding the surface resistance, when Examples 1, 3, 5, 7, 9 are compared with Comparative Example 1, and Examples 2, 4, 6, 8, 10 are compared with Comparative Example 2, the surface resistance value when using a silver nanowire ink including a low molecular weight urea compound is smaller than 1.1 times of the surface resistance value when using a silver nanowire ink without a low molecular weight urea compound. This reveals that the addition of the low molecular weight urea compound has only a small influence on the film conductivity.

On the other hand, regarding Comparative Examples 3 and 4 where silver nanowire ink mixed with benzotriazole was used, benzotriazole corresponding to the corrosion inhibitor described in Patent Document 2 and the chelator described in Patent Document 3, Comparative Example 3 showed a surface resistance out of the measurable range (resistance higher than 1000 Ω/sq), and Comparative Example 4 showed a surface resistance larger than 50 Ω/sq. Thus, the surface resistance value when using a silver nanowire ink including benzotriazole is larger than 1.3 times of the surface resistance value when using a silver nanowire ink without benzotriazole (Comparative Examples 1 and 2). Namely, the addition of benzotriazole largely damages the film conductivity. All of Examples and Comparative Examples showed the same total light transmittance value. This confirms that using the silver nanowire ink according to the present disclosure has no damage on the optical property (transparency).

The above results have proved that when the silver nanowire ink according to the present disclosure is used, a transparent electroconductive film having a preferable migration resistance can be obtained. Further, the results have revealed that for the purpose of maintaining a preferable conductivity, using the silver nanowire ink according to the present disclosure is superior than mixing a known corrosion inhibitor.

1. A silver nanowire ink comprising a low molecular weight urea compound having a urea bond in a molecule and having a molecular weight of 60 to 250, a silver nanowire, a binder resin, and a dispersion medium.

2. A silver nanowire ink according to claim 1, wherein a content of the low molecular weight urea compound in the silver nanowire ink is 0.02 to 0.20% by mass, a content of the silver nanowire is 0.01 to 1.50% by mass, and a content of the binder resin is 0.01 to 2.00% by mass.

3. A silver nanowire ink according to claim 1, wherein the low molecular weight urea compound is at least one selected from a group consisting of urea and a substituted urea compound in which one or two hydrogen atoms in the urea is substituted by an alkyl group with 1 to 3 carbon atoms or a phenyl group.

4. A silver nanowire ink according to claim 1, wherein the binder resin is ethyl cellulose or poly-N-vinylpyrrolidone.

5. A silver nanowire ink according to claim 1, wherein the dispersion medium contains water and at least one saturated monohydric alcohol having 1 to 3 carbon atoms and represented by CₙH₂ₙ₊₁OH (n being an integer of 1 to 3).

6. A silver nanowire ink according to claim 5, wherein the dispersion medium further contains at least one selected from a group consisting of ethylene glycol, propylene glycol, ethylene glycol monomethylether, ethylene glycol monoethylether, propylene glycol monomethylether, and propylene glycol monoethylether.

7. A transparent electroconductive film having a transparent substrate on which a transparent electroconductive layer made of a silver nanowire ink according to claim 1 is formed.

8. A transparent electroconductive film according to claim 7, wherein the transparent substrate is a film of cyclo olefin polymer, polycarbonate, or polyethylene terephthalate.
